(19) United States
(12) Patent Application Publication
(10) Pub. No.: US 2019/0107228 A1
(43) Pub. Date: Apr. 11, 2019

(54) CONTINUOUS ON-SITE MANUFACTURED CONCRETE PIPE

(71) Applicant: Mohammad R. Ehsani, Tucson, AZ (US)

(72) Inventor: Mohammad R. Ehsani, Tucson, AZ (US)

(21) Appl. No.: 15/730,689

(22) Filed: Oct. 11, 2017

(51) Int. Cl. F16L 1/038; F16L 9/08; F16L 9/133

(52) U.S. Cl. CPC F16L 1/038; F16L 9/133; F16L 9/085

(57) ABSTRACT

Methods are disclosed for on-site construction of continuous concrete pipes. In some embodiments a tunnel is bored in the ground instead of traditional excavation of a ditch for the pipe. At least one layer of concrete or other similar materials is sprayed/applied on the wall of the tunnel. Optionally a mesh of reinforcement material is laid over the concrete layer(s). Subsequently additional layer(s) of concrete is sprayed on the previous layers. The spraying process in these methods may be manual or mechanized. In other embodiments the soil removed from the tunnel may be used to mix the concrete. Utilizing the disclosed methods, new continuous pipes may be formed within old pipes or damaged pipes.

### CROSS-REFERENCE(S) TO RELATED APPLICATION(S)

This Non-Provisional Patent Application is related to the US Provisional Patent Application No. 62/355,505, entitled “3D Printed Pipe,” filed on 28 Jun. 2016 and to U.S. Provisional Patent Applications No. 62/355,505, entitled “3D Printed Pipe” filed on 28 Jun. 2016, the disclosures of both of which are hereby expressly incorporated by reference in their entirety, and the benefit of the priority date of the US Provisional Patent Applications No. 62/355,505 is hereby claimed under 35 U.S.C. § 119(e).

### TECHNICAL FIELD

This application relates generally to construction of pipes. More specifically, this application relates to a method for on-site construction of continuous concrete pipes.

### BRIEF DESCRIPTION OF THE DRAWINGS

The drawings, when considered in connection with the following description, are presented for the purpose of facilitating an understanding of the subject matter sought to be protected.

FIG. 1 show traditional method of laying pipes in a trench;

FIG. 2 illustrates the overall disclosed method;

FIG. 3 shows a perspective view of an unfinished concrete pipe, constructed according to the present disclosure; and

FIG. 4 shows an alternative reinforcement method according to an example embodiment of the present disclosure.

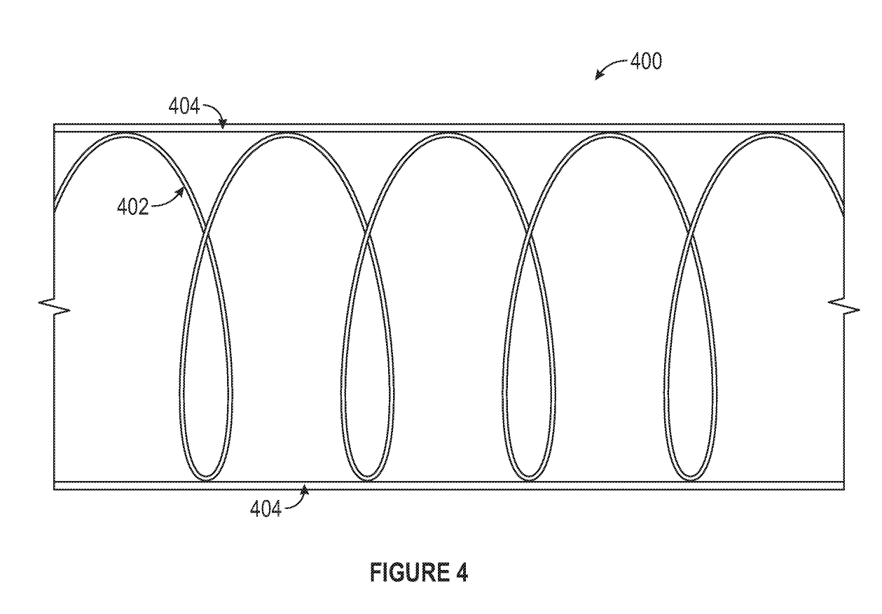

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description references using concrete or concrete and steel rebars to construct the underground pipes, it will be appreciated that the disclosure may include other curable and other reinforcement materials such as resin and various non-metallic or plastics such as FRP, HDPE, PVC, rubber, etc., to which the disclosed methods also apply. Furthermore, these methods may be utilized to construct new pipes inside old or damaged and corroded pipes, culverts, tunnels, or silos, and the like.

The disclosed methods teach the on-site manufacturing of lower cost, safer and environmentally sustainable pipes using the Additive Manufacturing (AM) technology (also known as Additive Printing and 3D Printing). The example pipes in this specification are basically made of concrete but many other materials such as resin may be used instead of or together with concrete. The pipe industry in the United States is approximately $68 Billion annually. Underground pipes typically account for around 30% of the total project cost. An objective of this innovation is to reduce that number to around 15-20% of total project cost. This, for example, would enable municipal owners to stretch their limited capital expenditure budgets and to better address their aging water and sewer infrastructure.

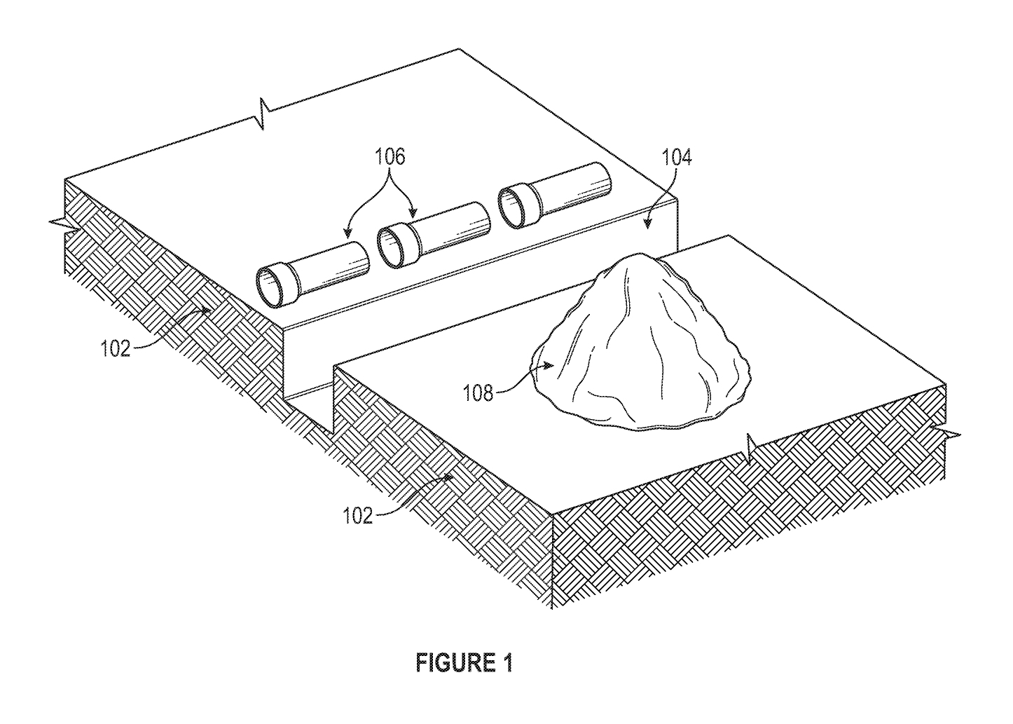

The traditional construction of a pipeline, as partly illustrated in FIG. 1, has remained virtually unchanged since its inception and includes the following steps:
1. Cut a trench 104 in the ground 102 for placement of the pipe
2. Pipe segments 106 are constructed in short segments in factories
3. Ship the pipe segments 106 via trucks to the jobsite
4. Unload the pipe segments 106 along the trench 104
5. Place and join the pipe segments 106 in the trench 104
6. Backfill and compact the trench 104 with appropriate fill material
7. Haul away the excess soil 108 from the site for disposal

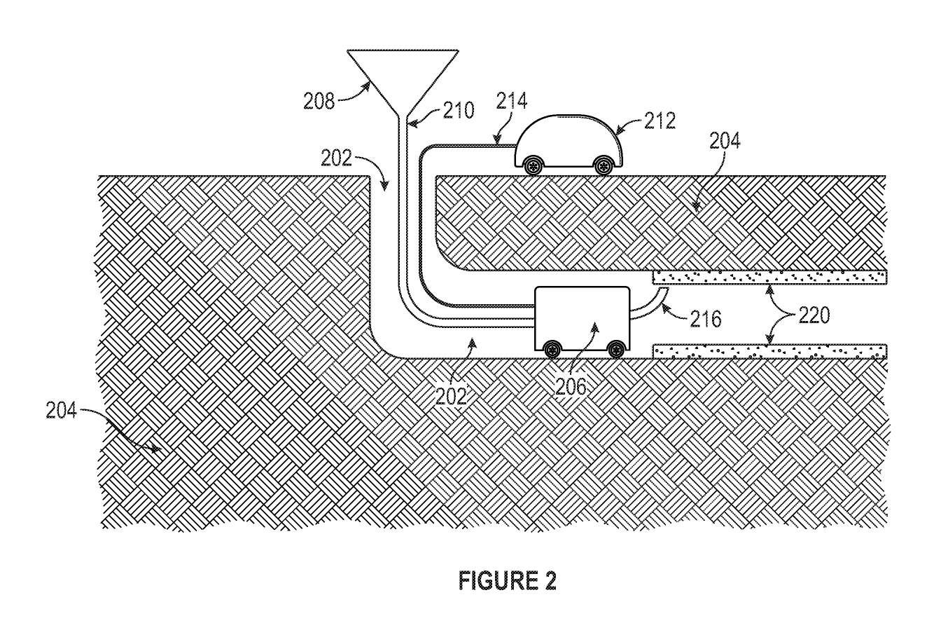

Briefly explained, the new method, as schematically illustrated in FIG. 2, includes boring a tunnel 202 in the ground 204, wherein the excavated soil may also be used to mix the concrete onsite. Concrete can either be mixed on site or mixed in a plant and delivered to the site. Pumping concrete from hopper 208 through a flexible tube/hose 210 into the tunnel 202 where, for example a robotic platform 206 will spray or place the concrete, layer by layer, on the wall of the tunnel 202 to build a pipe 220. The robotic platform or 3D printer 206 can be supported on wheels or tracks that allow it to move inside the tunnel 202. Electrical energy, for example, may be supplied to the robotic platform 206 by a generator 212 through cable 214. In some embodiments the concrete or any desired curable material will be dispensed and applied in a controlled manner whereby the width, length and rate of dispensing of the bead of concrete will be substantially controlled through the robot. In various embodiments the robotic platform 212 may also contain its own source of energy such as a battery or a gas generator. In some embodiment “spraying” may mean smearing, attaching, applying, rubbing, coating, or placing.

The diameter of the tunnel 202 is in general about the same as the outside diameter of the pipe 220 to be made. In some embodiments this process may be performed manually. In various embodiments at least a layer of reinforcement material is placed between the concrete layers. Reinforcing elements also will be installed manually or by a robot platform. Immediate cost saving is realized due to elimination of transportation of the pipes to the jobsite. Aadditional savings are obtained from reduced cost of storage and handling as well as reduction in fixed manufacturing equipment which results from on-site manufacturing of the pipes. A further advantage of the proposed pipe is in congested and developed areas where current technology that requires cutting of open trenches and associated traffic control adds significant costs to the project. In some cases, for example when a pipe must be placed under a developed city block, it is impossible to cut a trench under existing buildings for placement of the new pipe.

In some embodiments, to spray the tunnel 202 walls, a dry mix of sand, cement, etc. is pushed through a hose and water is transported in a parallel hose. The materials are mixed at the nozzle as they are sprayed on the wall of the tunnel. This system usually allows delivery of materials over a longer distance inside the tunnel compared to, for example, shotcrete.

While moving inside tunnel 202, the robot platform 206 will generate a continuous helical bead of concrete on the tunnel's wall. The thickness of this bead may be controlled by controlling the speed of the robot platform 206, the size of the dispensing nozzle, and the rate of dispensing of the concrete. The beads of concrete will be touching and slightly overlapping to eliminate any gaps in the concrete pipe 220. In various embodiments, this operation is repeated two or more times; with each pass laying a single continuous bead of concrete and adding to the thickness of the pipe 220 until the desired pipe thickness is achieved. Traditionally most pipes are made very thick because they get subjected to high stresses during lifting, handling and placement. However the disclosed pipe 220 does not require any lifting or handling and can therefore be built with thinner walls. The first layer of concrete can also fill any imperfections or unevenness in the surface of the tunnel such that the finished surface at the end of this operation is a smooth surface that is free of peaks and valleys.

In some embodiments the enclosed method is used to build a new pipe inside an existing old pipe, a tunnel, a culvert or a silo and, therefore, the old or existing pipe, the tunnel, the culvert and the silo are treated as Tunnels. In other embodiments reinforcement may not be used and only the layers of concrete, resin, Soil-cement slurry or CLSM, and high performance concrete mixtures may be applied to the tunnel walls. Using rheology modifiers, one can develop a liquid/fluid/flowable mix that is modified for speed of construction, as well as long-term strength, crack resistance, and resilient pipe systems. Also one may use cementitious materials that meet the UHPC (Ultra High Performance Concrete) criteria and that includes high compressive strength and significant ductility due to fiber reinforcement. It is possible that the process is conducted in two steps; a spray based CLSM layer followed by a higher strength fiber reinforced shotcrete to improve the strength, ductility and crack resistance.

The reinforcement for the pipe could also include impervious sheets preferably of non-corroding materials such as plastics, FRP, HDPE, PVC, etc. These sheets can be used as internal reinforcement to be placed between the concrete layers or they can be applied as a final topcoat to the finished pipe to provide a watertight moisture barrier liner for the pipe. This feature allows the use of thinner concrete wall pipes since there is no concern about protecting the reinforcing materials against potential corrosion. In various embodiments to repair a damaged pipe, any crack, holes, and other openings in the pipe is first patched before starting to spray curable material over the inside wall of the pipe.

In some embodiments, the applied FRP sheets can be designed to provide the entire reinforcing element for the pipe. Such FRP sheets can be placed as an internal layer withinn the finished thickness of the pipe or as an external layer that will come in contact with the fluids when the pipe is in service. The FRP sheets can include fibers in various x, y, and z directions (in plane and out of plane).

In yet another embodiment, a screed machine can be used to finish the concrete pipe to a smooth surface. Such equipment can include a rotating head that includes a trowel like device which travels in a helical fashion to remove any excess concrete from the pipe surface and give the pipe a smooth surface; at the same time this equipment can travel along the tunnel to make sure all points along the length of the pipe or tunnel are made smooth.

In some embodiments, a layer of paint or epoxy or other coatings such as polymers, polyurea, tar, etc. can be applied to the finished surface of the pipe to seal it against moisture intrusion and to also provide a smooth finished surface with minimal friction. Those experienced in the field realize that a smooth pipe surface is preferred for better flow and reduction of losses in the pipe. In other embodiments, this coating can be selected from a group of coatings that meet the NSF-61 Standards for potable pipes to ensure that the finished pipe meets the health and safety standards for drinking water. Yet in other embodiments, for example when the pipe is used to transport oil and /or gas, this coating can protect the pipe materials from chemical attack from the oil and gas.

In another embodiment, short fibers such as steel, polyethylene or other plastic fibers can be mixed with the concrete. Such short fibers can be used as a replacement for the above-mentioned reinforcing materials or they can be used in conjunction with the above reinforcing materials. Shorter fibers that are mixed in concrete increase the tensile strength of the concrete and delay its cracking.

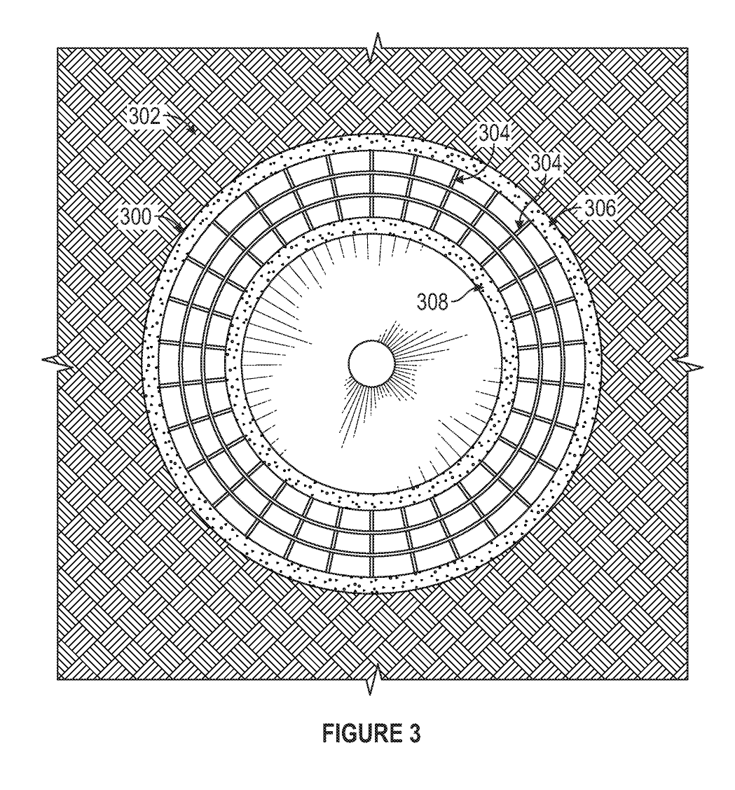

FIG. 3 shows a perspective view of an unfinished concrete pipe, constructed according to the present disclosure. As illustrated, a tunnel 300 has been made inside ground 302. A first concrete layer(s) 306 has also been sprayed or otherwise placed on the inside wall of the tunnel 300 and a mesh 304 of reinforcement material is placed against the first layer(s) 306. As shown, a second layer(s) of concrete is partially sprayed over the first layer(s) 306 and the reinforcement mesh 304. Based on the engineering calculations more reinforcement and/or impervious materials may be placed between different layers of this pipe.

The disclosed joint-less pipe will eliminate leakage and infiltration of water from joints, which is a serious cost and environmental concern with conventional pipes. A major problem for traditional pipe installation in urban environments is the lack of onsite storage and surface layout area for placing the pipe segments prior to installation. The disclosed methods will eliminate these complications because the pipe is manufactured seamlessly inside the tunnel during the tunnel boring operation Likewise, current techniques that require cutting of a trench, cannot be used with the alignment of the pipe passes under an existing building; this particular shortcoming of the current technolgy becomes more severe as more and more buildings are constructed worldwide and the need for providing pipelines for these developments also increases.

Daily loss of potable water to pipeline leakage is 4 liters per person worldwide. According to the American Society of Civil Engineers, 6 billion gallons of treated potable water leaks daily in the United States, which translates to 30-40% of drinking water leaking before a drop even reaches a single home. Pipe leakage typically occurs at the joints, which suffer deterioration over time. Subsequently, the adoption of continuous joint-less pipes become more popular.

The 30-year capital needs for maintaining and expanding the United States' water delivery systems, wastewater treatment plants, and sanitary and storm sewer systems range from approximately $91 billion in 2010, to $126 billion in 2020, to $195 billion by 2040. These estimates are considerably higher than previous ones because they account for escalated costs, a previous underreporting of local needs by communities, an extension of analysis from 20 to 30 years of needs, and a more detailed study of the needs to address raw sewage being discharged from combined sewage overflows. Cost to repair collapsing underground infrastructure over the next 20-25 years range from $500 billion in the US to $23 trillion globally. More than 40,000 sanitary sewer overflows occur every year from leaks or breaks in the US (US EPA). In less than 10 years, 45% of sewers in the US will be classified in poor or worse condition (US EPA).

The American Water Works Association (AWWA) has named this the Dawn of the Replacement Era, with the wave of increased spending predicted to last 30 years or more. The earliest pipes installed in the late 19th century have an average life span of about 120 years, but pipes installed after World War II have a shorter life span; about 75 years. For this reason, several generations of pipe will reach the end of their usable life within a couple of decades. Water mains must be replaced regardless of the number of current users, and because O&M needs are fulfilled by taxpayers, a smaller population translates to higher per capita replacement costs. Also, small and rural water utilities will experience higher-than-average per capita replacement costs due to the impact of a lack of economies of scale.

This innovation addresses a societal need and environmental issue that is becoming increasingly important due to climate change, population growth and persistent water shortage in many parts of the United States and the world. The disclosed methods offer economical solutions for four primary markets: (1) direct bury (open cut) installation; (2) Horizontal Directional Drilling (HDD); (3) Axis Guided Boring; and (4) Slip Lining of existing pipe; the latter three markets fall under the general category of “Trenchless” installation.

A major expense associated with direct bury projects is the cost and environmental impact of shipping the pipes from the plant and storage of the pipes on the job site. As an example, a 5-mile long project for 84-inch diameter pipe requires 3300 pieces of 8-ft long pipes. An 18-wheel trailer can carry only four pipes at a time; this leads to 825 round trips. If the jobsite is 50 miles from the plant, over 82,500 miles must be driven to deliver all the pipes. This does not include the additional dump trucks needed to haul the excavated soil away from the site. The cost of such shipment and the environmental impact of the traffic is tremendous but will be totally eliminated by the disclosed new methods.

The design of the pipes in most cases are controlled by the stresses induced during transportation and installation; this along with the bell and spigot joints lead to heavier pipes with thicker walls compared to the pipes manufactured by the proposed methods. The joints where the pipe segments are connected together are a major source of leakage and infiltration with associated maintenance cost for the entire life of the pipeline. Currently, traditional pipe manufacturers construct their pipes in massive manufacturing facilities and then transport inventory directly to the jobsite. Product is sold to contractors, who are required to purchase specific pipe material based on the specifications created by design engineers and owners for a particular project.

The traditional practice is inefficient, costly, poses danger to workers/general public (due to open cut trenches) and unsustainable. In contrast, the disclosed methods consists of the following steps (FIG. 2):
1. Bore a horizontal tunnel in the ground with a diameter similar to that of the intended pipe to be installed
2. Optionally apply a coating to the interior surface of the tunnel to stabilize the tunnel and prevent its partial collapse before the new pipe is constructed
3. Setup a small portable concrete batching plant at the end(s) of the tunnel
4. Mix a concrete; preferably utilizing the spoils removed from the tunnel
5. Use a robot platform to apply or “spray” a layer of concrete to the interior surface of the tunnel
6. Optionally repeat step 4 for additional layer(s) of concrete
7. Optionally use a robot platform to place reinforcement materials on the concrete surface
8. Repeat step 4 for at least one additional layer of concrete
9. Optionally haul away the remaining excess soil from the site

As mentioned before, the robot platform in these processes may be replaced by manual labor or any other method for applying layers of concrete or other curable materials to the interior surface of the tunnel. Some of the concrete nozzles may include serrated teeth to make sure that a relatively rough surface profile is left behind for improved bonding to subsequent layers. Based on the calculations of the internal pressure of the pipe and the longitudinal forces (or thrust), the size and spacing of the reinforcing bars/strips can be determined. These reinforcing cages can be coiled into a diameter smaller than that of the inside of the pipe and taken inside the pipe with the help of a robot or manually. Once they reach the desired location, the coil is opened and its elastic memory will force the reinforcing grid to expand and attach itself to the inner surface of the pipe. Those skilled in the art realize that sufficient overlap length should be provided for the reinforcing elements in the hoop direction and along the axis of the pipe to make these elements perform as continuous reinforcement. Another method is to use a coil of reinforcing element that can be placed as continuous hoop 402 reinforcement inside the pipe between successive layers of concrete. These are available in both steel and carbon or glass FRP. In this case, if desired, the longitudinal reinforcement 404 for the pipe must be placed separately. In some cases, the component of the strength provided by the spiral reinforcement along the axis of the pipe may be sufficient and no additional reinforcement may be necessary.

In another embodiment the reinforcing materials can be carbon or glass FRP or other plastic materials. These materials are very lightweight and strong and they do not corrode.

Some of the advantages of the disclosed methods are as follows.
a. The disclosed methods allow construction of new pipelines under city blocks that are covered with buildings or heavily travelled streets with minimal disruption at the ground surface level.
b. The disclosed methods eliminate all transportation costs associated with delivery of finished pipe segments from the manufacturing facility to the jobsite.
c. The pipe wall thickness will be reduced since it will not be subjected to the large stresses during the handling and placement process.
d. Nearly all joints will be eliminated, thereby eliminating all water losses at joints.
e. Direct-bury that requires open-cut trenches is a much more dangerous activity for the workers which has a significant economic impact due to road closure, traffic control, etc.
f. The building of the new pipes from locally extracted soil from the tunnel makes the pipe cheaper and more environmentally sustainable.
g. There will be much less soil to be hauled away from the job site; this leads to less expense and a more sustainable solution. Compared to HDD and other trenchless
h. it requires a significantly smaller laydown area, much less disruption to the nearby residents and the traveling public.
i. It is easier to accommodate more complex curves and profiles; this is particularly significant for projects in congested urban areas.
j. The pipe is made out of reinforced concrete, resin, or fiber-reinforced resin with a long service history.
k. Reduction of the overall project cost by 20%-25% in addition to providing a more sustainable solution, safer working conditions, with smaller carbon footprint.

Although the intended use of these methods at the present is for long segments of transmission pipes with few fittings, there may be occasional need for connections and fittings. These can be incorporated into the pipe. For example, it is possible to program the robot to build a circular ring of a particular diameter at a location where a smaller pipe will connect to this pipe. Special reinforcing elements can also be placed around such openings. Current pipeline construction mostly utilizes bends that are 22.5, 45 or 90 degrees. This is primary due to the high cost associated with building molds for such fittings. In contrast, the proposed technology can easily build a pipe along any bend angle in the tunnel. In fact, one of the advantages of this technique is that it allows the users to build a pipe in a complex geometry that includes any horizontal and/or vertical bend as long as the boring equipment can produce the profile. This is a noteworthy benefit in future pipeline projects where existing obstructions and pipelines in urban areas may demand a pipeline with a complex geometry. Even when the profile of a pipe follows a smooth curve, for example when a pipeline is placed in a parabolic profile under a freeway or a river, current concrete pipe segments that have a flush end do not allow such geometries. Connecting such pipe segments together will result in numerous leaking joints along the pipeline.

Although in most applications, the temperature fluctuations at a depth a few feet below the ground level are minimal, there may be a need to provide an occasional joint, for example, every one to two thousand feet in the pipeline to allow for expansion and contraction of the pipeline. Such joints can be constructed, for example, as bell and spigot or other types of joints using the robots and by optionally adding additional reinforcing materials, and rubber seals, gaskets, or similar materials.

The material(s) sprayed or attached to the tunnel surface may be fast curing or may be subjected to heat, UV light, or the like, to speed up the curing process. These may be performed manually or mechanically as well.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B,” and also the phrase “A and/or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

1. A method of manufacturing a continuous pipe on-site, the method comprising:
boring a tunnel in ground, having a cross-sectional shape and size similar to shape and size of the continuous pipe;
spraying at least a first layer of a first curable material to interior surface of the tunnel;
placing reinforcement material over the first layer of curable material;
applying at least a second layer of a second curable material over the first layer, wherein the second layer covers the reinforcement material and the first layer of the first curable material and wherein the resulting pipe solely bears all inside pressures and outside loads exerted on the pipe.

2. The method of claim 1, wherein the boring is performed manually or mechanically or by a robot.

3. The method of claim 1, wherein applying means spraying, smearing, attaching, rubbing, coating, or placing.

4. The method of claim 1, wherein the second curable material is same as the first curable material or different.

5. The method of claim 1, wherein the curable material is polyester, plastic, vinyl ester, epoxy, concrete, grout, or cementitious grout.

6. The method of claim 5, wherein at least some of the spoils removed from the tunnel are used in making of the concrete.

7. The method of claim 5, wherein concrete, grout or plastic contains short reinforcing fibers.

8. The method of claim 1, further including an additional step of finishing an inner surface of the pipe to achieve a smooth surface.

9. The method of claim 1, wherein reinforcement material-s are rebars, fibers, short fibers, FRP fabric, wire, and/or wire mesh.

10. A method of constructing a continuous pipe on-site, the method comprising:
boring a tunnel in ground, having a cross-sectional shape and size similar to outside shape and size of the intended continuous pipe; and
applying a layer of a curable material to interior surface of the tunnel to form the continuous pipe, wherein the resulting pipe solely bears all inside pressure and outside loads exerted on the pipe.

11. The reinforcement shell of claim 10, further including a step of placing a layer of reinforcement material over the layer of curable material.

12. The method of claim 10, wherein the boring is performed manually or mechanically or by a robot.

13. The method of claim 10, wherein applying means spraying, smearing, attaching, rubbing, coating, or placing.

14. The method of claim 11, wherein a second curable material is applied over the layer of reinforcement material.

15. The method of claim 10, wherein the curable material is polyester, plastic, vinyl ester, epoxy, concrete, grout, or cementitious grout and wherein mixing concrete may utilize spoils removed from the tunnel and wherein the curable material may contain reinforcing fibers.

16. The method of claim 10, further including an additional step of finishing an inner surface of the pipe to achieve a smooth surface.

17. The method of claim 10, wherein the tunnel is vertical, horizontal, slanted, or is not straight.

18. (canceled)

19. (canceled)

20. The method of claim 1, further including a step of applying a desired coating to a last layer of the curable material to achieve a smooth surface inside the repaired pipe, wherein applying means spraying, smearing, attaching, rubbing, coating, or placing.
